(19) United States
(12) Patent Application Publication
(10) Pub. No.: US 2026/0113392 A1
(43) Pub. Date: Apr. 23, 2026

(54) RESERVED PROTOCOL DATA UNIT SET SEQUENCE NUMBERS

(71) Applicant: Qualcomm Incorporated, San Diego, CA (US)

(72) Inventors: Liangping MA, San Diego, CA (US); Sitaramanjaneyulu KANAMARLAPUDI, San Diego, CA (US); Sebastian SPEICHER, Wallisellen (CH)

(21) Appl. No.: 19/318,964

(22) Filed: Sep. 4, 2025

Related U.S. Application Data
(60) Provisional application No. 63/710,494, filed on Oct. 22, 2024.

(51) Int. Cl. H04L 69/22

(52) U.S. Cl. CPC H04L 69/22

(57) ABSTRACT

Various aspects of the present disclosure generally relate to wired and/or wireless communication. Some aspects more specifically relate to quality of service handling requirements for lone protocol data units (PDUs). In some aspects, a network entity may assign reserved PDU set sequence numbers (PSSNs) to lone PDUs. For example, a user plane function may assign reserved PSSNs to lone downlink PDUs, and a network node may assign reserved PSSNs to lone uplink PDUs.

### CROSS-REFERENCE TO RELATED APPLICATION

This Patent Application claims priority to U.S. Provisional Patent Application No. 63/710,494, filed on Oct. 22, 2024, entitled “RESERVED PROTOCOL DATA UNIT SET SEQUENCE NUMBERS,” and assigned to the assignee hereof. The disclosure of the prior Application is considered part of and is incorporated by reference into this Patent Application.

### FIELD OF THE DISCLOSURE

Aspects of the present disclosure generally relate to wired and/or wireless communication and specifically relate to techniques, apparatuses, and methods associated with reserved protocol data unit set sequence numbers.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a network entity for wireless communication. The network entity may include a processing system that includes one or more processors and one or more memories coupled with the one or more processors. The processing system may be configured to cause the network entity to receive a protocol data unit (PDU) that is not associated with any PDU set. The processing system may be configured to cause the network entity to transmit the PDU encapsulated in a packet including a header that indicates a PDU set sequence number (PSSN) reserved for PDUs that are not associated with any PDU set.

Some aspects described herein relate to a user equipment (UE) for wireless communication. The UE may include a processing system that includes one or more processors and one or more memories coupled with the one or more processors. The processing system may be configured to cause the UE to receive a first indication of a PSSN reserved for PDUs that are not associated with any PDU set. The processing system may be configured to cause the UE to transmit a second indication of the PSSN.

Some aspects described herein relate to a method for wireless communication by a network entity. The method may include receiving a PDU that is not associated with any PDU set. The method may include transmitting the PDU encapsulated in a packet including a header that indicates a PSSN reserved for PDUs that are not associated with any PDU set.

Some aspects described herein relate to a method for wireless communication by a UE. The method may include receiving a first indication of a PSSN reserved for PDUs that are not associated with any PDU set. The method may include transmitting a second indication of the PSSN.

Some aspects described herein relate to an apparatus for wireless communication. The apparatus may include means for receiving a PDU that is not associated with any PDU set. The apparatus may include means for transmitting the PDU encapsulated in a packet including a header that indicates a PSSN reserved for PDUs that are not associated with any PDU set.

Some aspects described herein relate to an apparatus for wireless communication. The apparatus may include means for receiving a first indication of a PSSN reserved for PDUs that are not associated with any PDU set. The apparatus may include means for transmitting a second indication of the PSSN.

Some aspects described herein relate to a non-transitory computer-readable medium that stores a set of instructions for wireless communication by a network entity. The set of instructions, when executed by one or more processors of the network entity, may cause the network entity to receive a PDU that is not associated with any PDU set. The set of instructions, when executed by one or more processors of the network entity, may cause the network entity to transmit the PDU encapsulated in a packet including a header that indicates a PSSN reserved for PDUs that are not associated with any PDU set.

Some aspects described herein relate to a non-transitory computer-readable medium that stores a set of instructions for wireless communication by a UE. The set of instructions, when executed by one or more processors of the UE, may cause the UE to receive a first indication of a PSSN reserved for PDUs that are not associated with any PDU set. The set of instructions, when executed by one or more processors of the UE, may cause the UE to transmit a second indication of the PSSN.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and the accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example associated with protocol data unit (PDU) transmission.

FIG. 4 is a diagram illustrating examples associated with issues in PDU transmission.

FIG. 5 is a diagram illustrating an example associated with signaling for reserved protocol data unit set sequence numbers (PSSNs).

FIG. 6 is a diagram illustrating examples associated with one or more values of each bit of a PSSN being reserved for lone PDUs.

FIG. 7 is a flowchart illustrating an example process performed, for example, at a network entity or an apparatus of a network entity that supports reserved PSSNs in accordance with the present disclosure.

FIG. 8 is a flowchart illustrating an example process performed, for example, at a user equipment (UE) or an apparatus of a UE that supports reserved PSSNs in accordance with the present disclosure.

FIG. 9 is a diagram of an example apparatus for wireless communication, such as a network entity, that supports reserved PSSNs in accordance with the present disclosure.

FIG. 10 is a diagram of an example apparatus for wireless communication, such as a UE, that supports reserved PSSNs in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A lone protocol data unit (PDU) is a PDU that does not belong to any PDU set. For example, the lone PDU may not include a real-time transport protocol (RTP) header extension for PDU set marking. In some examples, a lone PDU may enter a user plane function (UPF) in a downlink, and the UPF may handle the lone PDU by mapping the lone PDU to a PDU set and identifying PDU set information for the lone PDU. The UPF may then transmit the lone PDU to a radio access network (RAN) encapsulated in a general packet radio service (GPRS) tunneling protocol (GTP) user plane (GTP-U) packet. In some examples, the GTP-U packet may include a header that carries the PDU set information.

In some examples, the PDU set information identified by the UPF may include a PDU set sequence number (PSSN). A PSSN is a sequence number (for example, a 10-bit unsigned integer) of a PDU set to which a PDU belongs. In some examples, the UPF may identify a PSSN for a lone PDU by assigning a PSSN that is one value greater than a largest PSSN that the UPF has identified. For example, if the UPF has not received any lone PDUs and the largest PSSN that the UPF has identified is X, and then the UPF receives a lone PDU, then the UPF may assign to the lone PDU a PSSN of X+1. This approach may help to ensure continuity of the PSSNs.

However, assigning a PSSN that is one value greater than a largest PSSN that the UPF has identified may negatively impact application performance. For example, in this approach, the UPF may modify the PSSN of every PDU set received after the lone PDU, which may increase memory and/or processing resource consumption at the UPF, introduce delay (for example, jitter), and/or limit throughput. These negative impacts may be exacerbated in examples where the UPF handles large amounts of traffic. Additionally or alternatively, a dependent PDU set may have a PSSN and may be associated with a PSSN of a correlated PDU set on which the dependent PDU set depends. In this approach, the UPF may modify both PSSNs in a dependent PDU set of a PDU that is received after a lone PDU. Moreover, depending on the order in which the UPF receives various PDUs, the difference between the two PSSNs may change over time, which may prevent the UPF from using a difference between the PSSNs to identify an updated value for the correlated PSSN. As a result, the UPF may store PSSN mappings over time, which may further increase memory and/or processing resource consumption at the UPF, introduce delay, and/or limit throughput. Additionally or alternatively, this approach may be unable to correctly convey PDU set correlation information in examples involving out-of-order delivery of PDU sets. For example, if a lone PDU arrives at the UPF during an out-of-order delivery of PDU sets, then the UPF may re-assign PSSNs incorrectly.

Various aspects relate generally to quality of service (QoS) handling requirements for lone PDUs. Some aspects more specifically relate to PDU-set-based QoS handling for lone PDUs. In some aspects, a network entity may assign reserved PSSNs to lone PDUs. For example, a UPF may assign reserved PSSNs to lone downlink PDUs, and a network node may assign reserved PSSNs to lone uplink PDUs. In some aspects, values for a subset of bits in the PSSN may be reserved for lone PDUs. For example, a prefix of the PSSN may distinguish whether the PSSN is reserved for lone PDUs or for PDUs having marked PDU sets. In some examples, the bits other than the subset of bits may increase monotonically as lone PDUs and/or PDU sets arrive at the network entity. In some aspects, values for all bits in the PSSN may be reserved for lone PDUs. For example, the same reserved PSSN (for example, a PSSN having all 1-bits) may be used for all lone PDUs.

Particular aspects of the subject matter described in this disclosure can be implemented to realize one or more of the following potential advantages. In some examples, the described techniques can be used to partition PSSNs assigned to lone PDUs and PSSNs assigned to other PDUs, thereby helping to reduce memory and/or processing resource consumption, reduce delay, and/or increase throughput. Reserving values for a subset of bits in the PSSN may enable different lone PDUs to be assigned different PSSNs. Reserving values for all bits in the PSSN for lone PDUs may help to further reduce memory and/or processing resource consumption.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

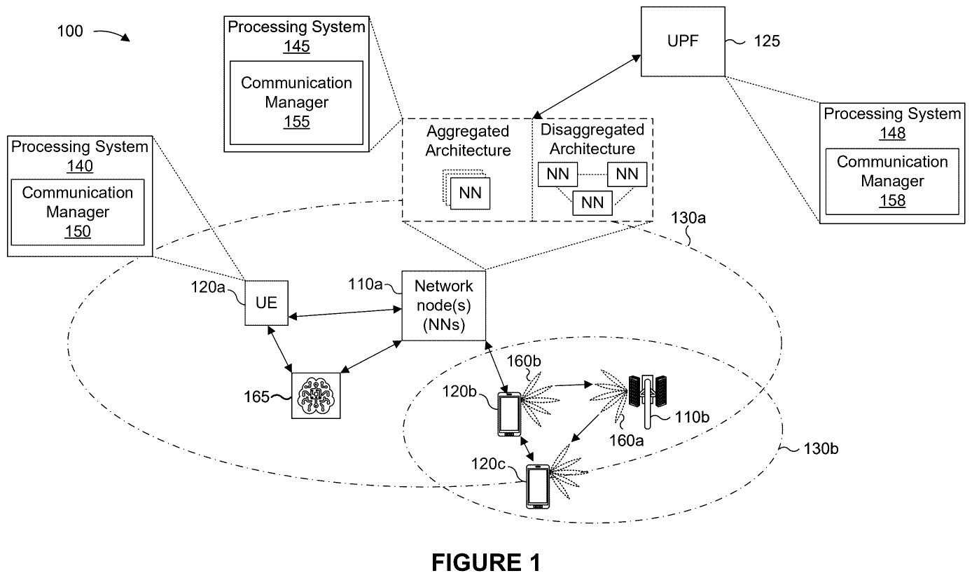

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple user equipments (UEs) 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110. In some examples, the core network may include a UPF 125. The UPF 125 may be responsible for handling user plane data. For example, the UPF 125 may transmit user plane data in the form of PDUs between one or more network nodes 110 and a data network.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110, a UE 120, and/or a UPF 125 may include one or more devices, components, or systems that enable communication with other devices, components, or systems of the wireless communication network 100. For example, a UE 120, a network node 110, and a UPF 125 may each include one or more chips, system-on-chips (SoCs), chipsets, packages, or devices that individually or collectively constitute or comprise a processing system, such as a processing system 140 of the UE 120, a processing system 145 of the network node 110, or a processing system 148 of the UPF 125. A processing system (for example, the processing system 140, the processing system 145, and/or the processing system 148) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, and the processing system 148 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

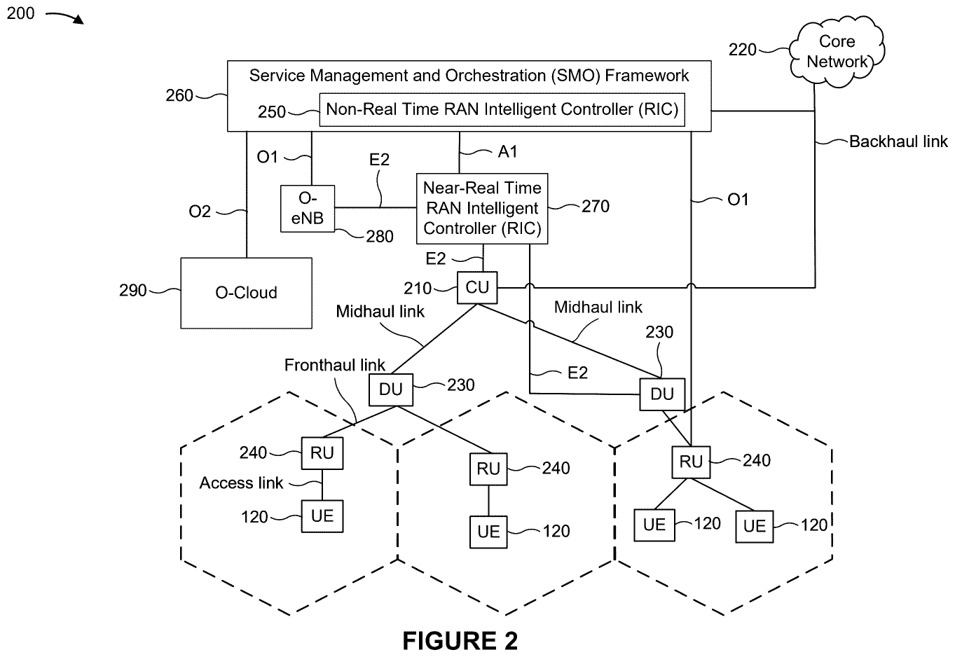

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or the processing system 140, respectively, and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive a first indication of a PSSN reserved for PDUs that are not associated with any PDU set; and transmit a second indication of the PSSN. Additionally or alternatively, the communication manager 150 may perform one or more other operations described herein.

In some aspects, the network node 110 may include a communication manager 155. As described in more detail elsewhere herein, the communication manager 155 may receive a PDU that is not associated with any PDU set; and transmit the PDU encapsulated in a packet including a header that indicates a PSSN reserved for PDUs that are not associated with any PDU set. Additionally or alternatively, the communication manager 155 may perform one or more other operations described herein.

In some aspects, the UPF 125 may include a communication manager 158. As described in more detail elsewhere herein, the communication manager 158 may receive a PDU that is not associated with any PDU set; and transmit the PDU encapsulated in a packet including a header that indicates a PSSN reserved for PDUs that are not associated with any PDU set. Additionally or alternatively, the communication manager 158 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 (for example, including the UPF 125) via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

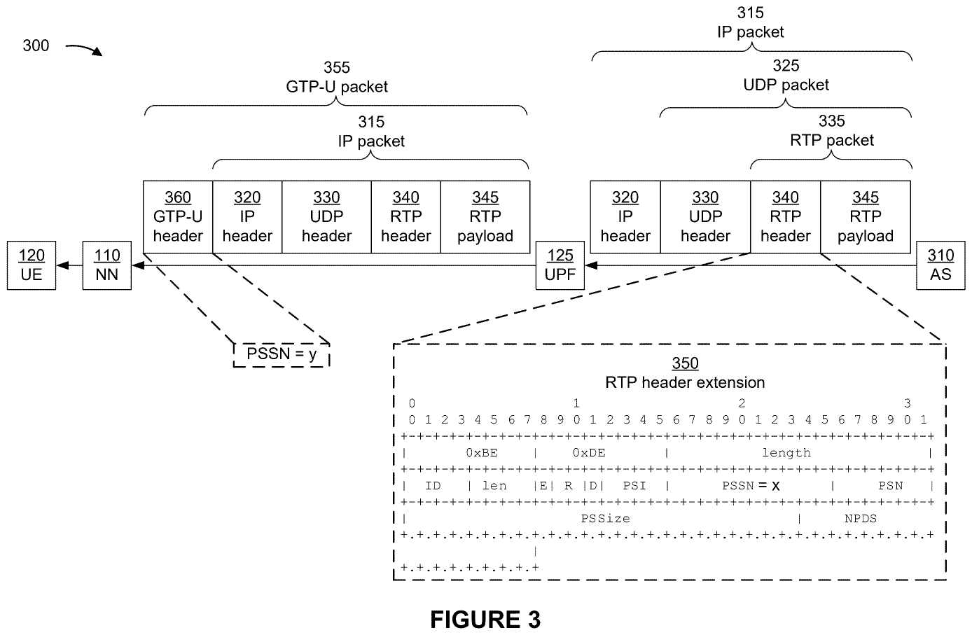

FIG. 3 is a diagram illustrating an example 300 associated with PDU transmission.

Example 300 shows a downlink path of a PDU. The path includes an application server (“AS”) 310, the UPF 125, a network node 110, and a UE 120. The application server 310 transmits, and the UPF 125 receives, the PDU in the form of an internet protocol (IP) packet 315. The IP packet 315 includes an IP header 320 that encapsulates a user datagram protocol (UDP) packet 325 (for example, the payload of the IP packet 315 may carry the UDP packet 325). The UDP packet 325 includes a UDP header 330 that encapsulates an RTP packet 335 (for example, the payload of the UDP packet 325 may carry the RTP packet 335). The RTP packet 335 includes an RTP header 340 and an RTP payload 345.

The RTP header 340 may include an RTP header extension for PDU set marking, such as a one-byte RTP header extension 350. The one-byte RTP header extension 350 may indicate a PSSN of the PDU (for example, “PSSN x”) or other PDU set information, such as that carried in a 1-bit field “E” indicating whether or not the PDU is the last PDU of a PDU set, a 1-bit field “D” indicating whether or not the PDU is at an end of a data burst, a 4-bit PDU set importance (PSI) field indicating an importance of the PDU set compared to other PDU sets in the same multimedia session as the PDU set, a 6-bit PDU sequence number (PSN) field indicating a sequence number of the PDU within the PDU set, a 24-bit PDU set size (PSSize) field indicating a total size of all PDUs of the PDU set, or a 16-bit number of PDUs in the PDU set field indicating a total number of PDUs belonging to the same PDU set, among other examples.

Upon receiving the IP packet 315, the UPF 125 may generate a GTP-U 355 packet that encapsulates the PDU and transmit the GTP-U packet 355 to the network node 110. The GTP-U packet 355 includes a GTP-U header 360 that encapsulates the IP packet 315 (for example, the payload of the GTP-U packet 355 may carry the IP packet 315). In some examples, the GTP-U header 360 may indicate a PSSN (for example, “PSSN y”) or other PDU set information. Upon receiving the GTP-U packet 355, the network node 110 may transmit at least a portion of the information conveyed by the GTP-U packet 355 to the UE 120.

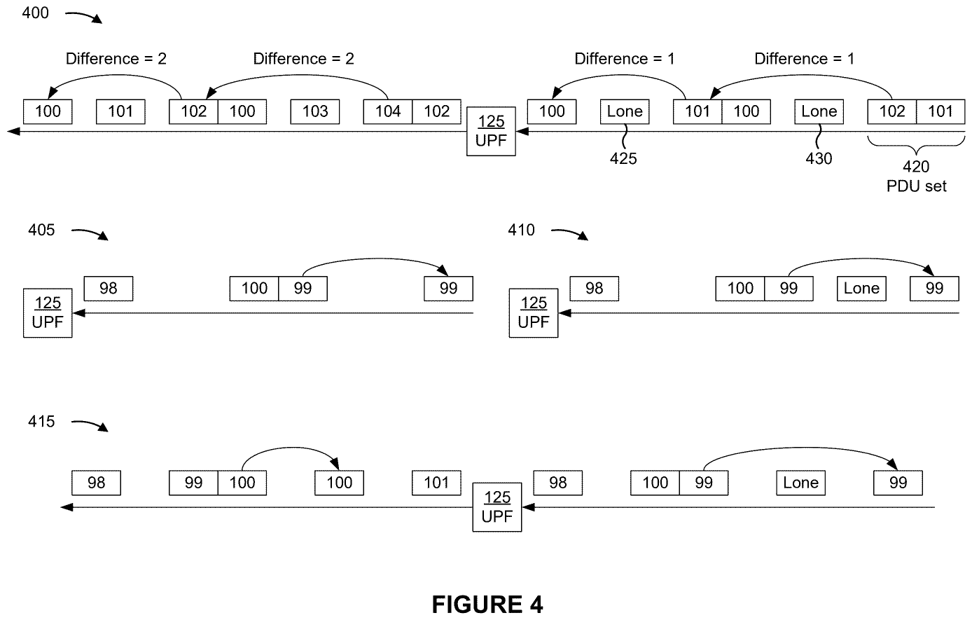

FIG. 4 is a diagram illustrating examples 400, 405, 410, and 415 associated with issues in PDU transmission.

In examples 400, 405, 410, and 415, the UPF 125 may act as a PDU session anchor (PSA). A PSA UPF may support PDU-set-based QoS handling by identifying PDUs that belong to PDU sets, identifying PDU set information for the PDUs, and transmitting the PDU set information to the network node 110 in a GTP-U packet header. If the PSA UPF receives a lone PDU (such as a PDU that does not belong to a PDU set according to a protocol description for PDU set identification), then the PSA UPF may map the lone PDU to a PDU set and identify PDU set information for the PDU. However, there is ambiguity as to how the PSA UPF should handle a lone PDU in the downlink (for example). For instance, it is unclear how the PSA UPF should set a PSSN (which is part of the PDU set information) for the lone PDU. In some examples, the UPF may identify a PSSN for a lone PDU by assigning a PSSN that is one value greater than a largest PSSN that the UPF has identified. For example, if the UPF has not received any lone PDUs and the largest PSSN that the UPF has identified is X, and the UPF receives a lone PDU, then the UPF may assign to the lone PDU a PSSN of X+1. Although this approach may help to ensure continuity of the PSSNs, assigning a PSSN that is one value greater than a largest PSSN that the UPF has identified may negatively impact application performance. For example, in this approach, the UPF may modify the PSSN of every PDU set received after the lone PDU, which may increase memory and/or processing resource consumption at the UPF, introduce delay (for example, jitter), and/or limit throughput. These negative impacts may be exacerbated in examples where the UPF handles large amounts of traffic.

Additionally or alternatively, a dependent PDU set may have a PSSN and may be associated with a PSSN of a correlated PDU set on which the dependent PDU set depends. In this approach, the UPF may modify both PSSNs in a dependent PDU set of a PDU that is received after a lone PDU. Moreover, depending on the order in which the UPF receives various PDUs, the difference between the two PSSNs may change over time, which may prevent the UPF from using a difference between the PSSNs to identify an updated value for the correlated PSSN. In example 400, the UPF 125 may support PDU set correlation information by tracking PSSN mappings for PDU sets. For example, the PDU set 420 includes a PDU with PSSN 102 and a PDU with a correlated PSSN 101. Upon receiving the PDU set 420, the UPF 125 may map the PSSN 102 and the PSSN 101, which have a difference of 1. However, due to the presence of lone PDUs 425 and 430, upon transmitting the PDU set 420, the UPF 125 may map the PSSN 104 and the PSSN 102, which have a difference of 2. Thus, the UPF 125 may be unable to depend solely on the difference of 1 to map the correlated PSSN 101 to 103. As a result, the UPF may store PSSN mappings over time, which may further increase memory and/or processing resource consumption at the UPF, introduce delay, and/or limit throughput.

Additionally or alternatively, assigning a PSSN that is one value greater than a largest PSSN that the PSA UPF has identified may prevent the PSA UPF from correctly conveying PDU set correlation information in examples involving out-of-order delivery of PDU sets. For example, if a lone PDU arrives at the PSA UPF during an out-of-order delivery of PDU sets, then the PSA UPF may re-assign PSSNs incorrectly. Examples 405 and 410 are different scenarios in which the UPF may receive a PDU set with PSSN 99 out of order. In example 405, a lone PDU is not present before the PDU set with PSSN 99, and in example 410, the lone PDU is present before the PDU set with PSSN 99. As a result, upon receiving the PDU set with PSSN 100, the UPF 125 may be unable to identify whether or not the UPF 125 will receive a lone PDU before receiving the PDU set with PSSN 99. Thus, the UPF 125 may be unable to distinguish between the scenarios depicted in examples 405 and 410. If the UPF 125 assumes one of these scenarios upon receiving the PDU set with PSSN 100, and the other scenario occurs, then the resulting PDU set correlation information may be incorrect. For instance, in example 415, the UPF 125 may assume that there is no lone PDU before the PDU set with PSSN=99 (as shown in example 405) and the lone PDU may be present (as shown in example 410), resulting in incorrect PDU set correlation information.

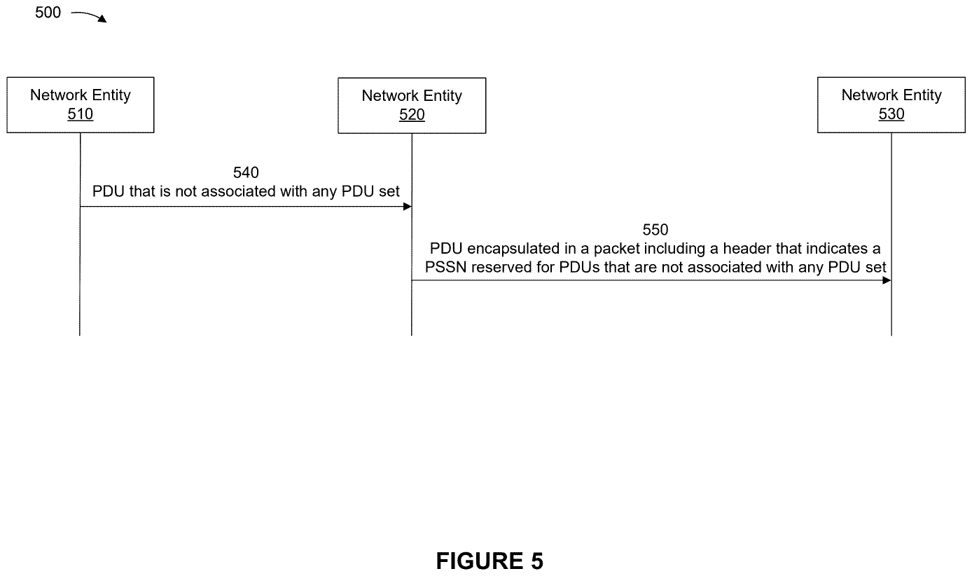

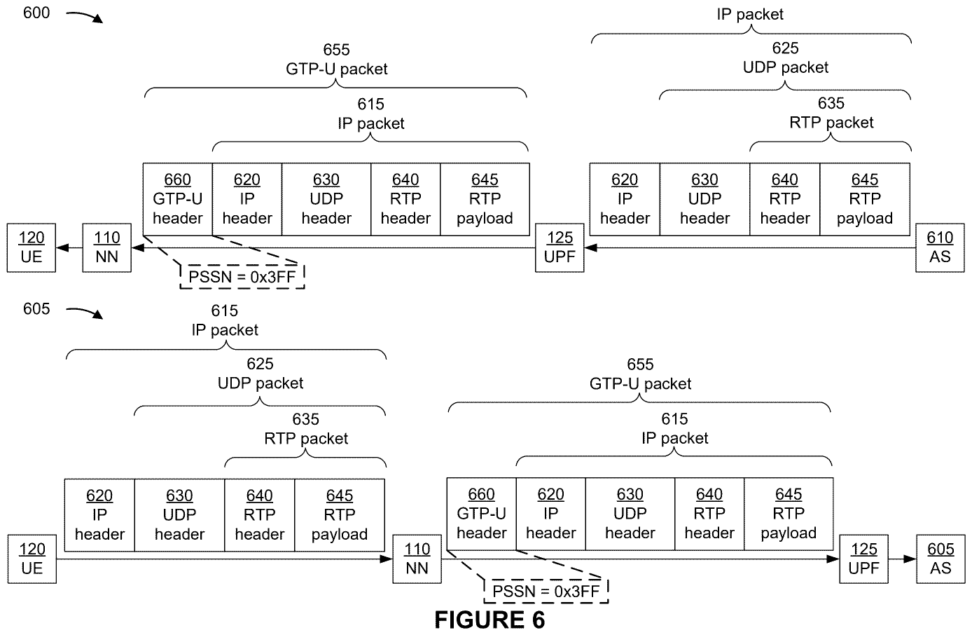

Accordingly, as described in greater detail below in connection with FIGS. 5-6, one or more PSSNs may be reserved for lone PDUs. The reserved PSSNs may help to mitigate issues described in connection with FIG. 4, such as by reducing memory or processing resource consumption at the UPF 125, lowering delay, improving throughput, or increasing accuracy of PDU set correlation information after the PDU sets traverse the UPF 125, among other examples.

FIG. 5 is a diagram illustrating an example 500 associated with signaling for reserved PSSNs. As shown in FIG. 5, a network entity 510, a network entity 520, and a network entity 530 may communicate with one another.

In a first operation 540, the network entity 510 may transmit, and the network entity 520 may receive, a PDU that is not associated with any PDU set. A PDU may be associated with a PDU set in that the PDU may belong to the PDU set (for example, the PDU may be grouped with zero or more other PDUs as part of the PDU set). The PDU may not be associated with any PDU set in that the PDU may not belong to any PDU set. For example, the PDU (for example, a lone PDU) may not carry a PSSN.

In some aspects, the PDU may be a downlink PDU. For example, the network entity 510 may be the AS 305, the network entity 520 may be the UPF 125, and the network entity 530 may be the network node 110. In some aspects, the PDU may be an uplink PDU. For example, the network entity 510 may be the UE 120, the network entity 520 may be the network node 110, and the network entity 530 may be the UPF 125.

In a second operation 550, the network entity 510 may transmit, and the network entity 520 may receive, the PDU encapsulated in a packet including a header that indicates a PSSN reserved for PDUs that are not associated with any PDU set. The header may be a section at the beginning of the packet that includes control information, such as the reserved PSSN. The PSSN may be reserved for lone PDUs (for example, PDUs associated with a PDU set may not be assigned the reserved PSSN). In some examples, after receiving the PDU, the network entity 520 may identify that the PDU is a lone PDU, assign the reserved PSSN to the PDU, and encapsulate the PDU in the packet including the header that indicates the reserved PSSN. In examples where the PDU is a downlink PDU, the UPF 125 may assign the reserved PSSN to the PDU. In examples where the PDU is an uplink PDU, the network node 110 may assign the reserved PSSN to the PDU. The PSSN being reserved for PDUs that are not associated with any PDU set may enable partitioning of PSSNs assigned to lone PDUs and PSSNs assigned to other PDUs, thereby helping to reduce memory and/or processing resource consumption, reduce delay, and/or increase throughput.

In some aspects, one or more values of a subset of a set of bits of the PSSN may be reserved for the PDUs that are not associated with any PDU set. For example, the PSSN may include the set of bits (for example, 10 bits), and the value(s) of the subset of the set of bits (for example, less than 10 bits) may be reserved for lone PDUs. The subset, which may be a prefix of the PSSN, may be used to distinguish between PSSNs reserved for lone PDUs and PSSNs that are not reserved for lone PDUs (for example, PSSNs that may be used for PDUs that are part of a PDU set as marked by a traffic source). The one or more values of the subset of the set of bits of the PSSN being reserved for the PDUs that are not associated with any PDU set may enable different lone PDUs to be assigned different PSSNs, thereby improving flexibility of assignments.

In some aspects, the subset may include a most significant bit (MSB) of the PSSN. The MSB may be a highest-order (for example, left-most) bit in a binary representation of the PSSN. In some examples, the MSB of the PSSN may indicate whether the PSSN has been assigned to a lone PDU or a PDU belonging to a PDU set marked by a traffic source. In some aspects, a value of the MSB may be 1. For example, if the MSB is set to 1, then the PSSN may identify a lone PDU; and if the MSB is set to 0, then the PSSN may identify a PDU as being part of a PDU set marked by the traffic source.

In some aspects, the subset may include an MSB of the PSSN and a second MSB of the PSSN. The second MSB may be a second-highest-order (for example, second-left-most) bit in a binary representation of the PSSN. In some examples, the two MSBs of the PSSN may indicate whether the PSSN has been assigned to a lone PDU or a PDU belonging to a PDU set marked by a traffic source. For example, if the MSBs are set to 11, then the PSSN may identify a lone PDU; and if the MSB is set to 00, 01, or 10, then the PSSN may identify a PDU as being part of a PDU set marked by the traffic source. The subset including the MSB of the PSSN and the second MSB of the PSSN may provide a greater range of PSSNs to be assigned to marked PDU sets, such as in scenarios where the quantity of marked PDU sets is greater than the quantity of lone PDUs.

In some aspects, one or more values of each bit of the PSSN may be reserved for the PDUs that are not associated with any PDU set. For example, all bits of the PSSN may indicate whether the PSSN has been assigned to a lone PDU or a PDU belonging to a PDU set marked by a traffic source. For example, if all bits of the PSSN are set to 1 (for example, 0x3FF in a 10-bit PSSN), then the PSSN may identify a lone PDU. For example, an all-1 PSSN may be used for all lone PDUs. In examples where the PDU is a downlink PDU, the UPF 125 may assign a reserved PSSN having a value of 0x3FF to all lone PDUs. In examples where the PDU is an uplink PDU, the network node 110 may assign a reserved PSSN having a value of 0x3FF to all lone PDUs. The one or more values of each bit of the PSSN being reserved for the PDUs that are not associated with any PDU set may help to further reduce memory and/or processing resource consumption.

In some aspects, the PSSN may be stored in a memory of the network entity 520. For example, the PSSN may be predetermined, such that specific values of the reserved PSSN are designated in advance (such as by being specified in a communication standard). The predetermined PSSN may be stored in the memory of the network entity 520. For example, the predetermined PSSN may be static (for example, the predetermined PSSN may not be subject to modification while stored in the memory).

In some aspects, the network entity 520 may receive an indication of the PSSN. For example, the indication of the PSSN may be transmitted as part of a negotiation procedure whereby network entities mutually agree on specific values of reserved PSSNs (for example, rather than the reserved PSSNs being predetermined). As a result, the negotiation procedure may enable values of reserved PSSNs to be dynamically assigned.

In some aspects, the PDU may be a downlink PDU, the network entity 520 may be the UPF 125, and the network entity 520 may receive transport protocol assistance information that includes the indication of the PSSN. The transport protocol assistance information may include control information relating to a transport protocol (for example, RTP or secure RTP (SRTP), among other examples) used by a service data flow provided by an application function (AF) to a network. For example, the transport protocol assistance information may be protocol description signaling transmitted from the UE 120 to an application function (AF), from the AF to a policy control function (PCF), and from the PCF to the UPF 125.

In some aspects, the PDU may be an uplink PDU, the network entity 510 may be the UE 120, the network entity 520 may be the network node 110, and the UE 120 may transmit, and the network node 110 may receive, UE assistance information that includes the indication of the PSSN. The UE assistance information may be data transmitted by the UE 120 to the network node 110 that provides details or recommendations (for example, protocol preferences or configuration parameters, among other examples) to assist the network node 110 in managing wireless communications. For example, the indication of the PSSN may be an outcome of the negotiation procedure, and the UE assistance information may enable the UE 120 to inform the network node 110 of the outcome. In some examples (for example, during the negotiation procedure), the UE 120 may receive an indication of the PSSN, which the UE 120 may then transmit to the network node 110 via the UE assistance information. For example, the UE 120 may receive a session setup message that includes the indication of the PSSN. The session setup message may be transmitted during the negotiation procedure (for example, the negotiation procedure may be part of a session setup procedure between endpoints). For example, the negotiation procedure may involve exchanges of session description protocol (SDP) offer and answer messages, resulting in one or more values of the reserved PSSN(s).

FIG. 6 is a diagram illustrating examples 600 and 605 associated with one or more values of each bit of a PSSN being reserved for lone PDUs.

In some aspects, the PDU may be an IP packet, the packet may be a GTP-U packet, and the header may be a GTP-U header. Example 600 shows a downlink path of the PDU. The path includes an application server (“AS”) 610, a UPF 125, a network node 110, and a UE 120. The application server 610 transmits, and the UPF 125 receives, the IP packet 615. The IP packet 615 includes an IP header 620 that encapsulates a UDP packet 625 (for example, the payload of the IP packet 615 may carry the UDP packet 625). The UDP packet 625 includes a UDP header 630 that encapsulates an RTP packet 635 (for example, the payload of the UDP packet 625 may carry the RTP packet 635). The RTP packet 635 includes an RTP header 640 and an RTP payload 645. The RTP header 640 may not include an RTP header extension for PDU set marking. For example, the RTP header 640 may not include a PSSN (for example, the IP packet 615 may be a lone PDU).

Upon receiving the IP packet 615, the UPF 125 may generate the GTP-U packet 655 that encapsulates the IP packet 615 and transmit the GTP-U packet 655 to the network node 110. The GTP-U packet 655 includes a GTP-U header 660 that encapsulates the IP packet 615 (for example, the payload of the GTP-U packet 655 may carry the IP packet 615). In some examples, the GTP-U header 660 may indicate a PSSN (for example, “PSSN 0x3FF”) or other PDU set information. For example, the PSSN may be an all 1-bit PSSN reserved for lone PDUs. Upon receiving the GTP-U packet 655, the network node 110 may transmit at least a portion of the information conveyed by the GTP-U packet 655 to the UE 120.

Example 605 shows an uplink path of the PDU. The path includes a UE 120, a network node 110, a UPF 125, and an AS 610. The UE 120 transmits, and the network node 110 receives, the IP packet 615. Upon receiving the IP packet 615, the network node 110 may generate the GTP-U 655 packet that encapsulates the IP packet 615 and transmit the GTP-U packet 655 to the UPF 125. Upon receiving the GTP-U packet 655, the UPF 125 may transmit at least a portion of the information conveyed by the GTP-U packet 655 to the AS 605.

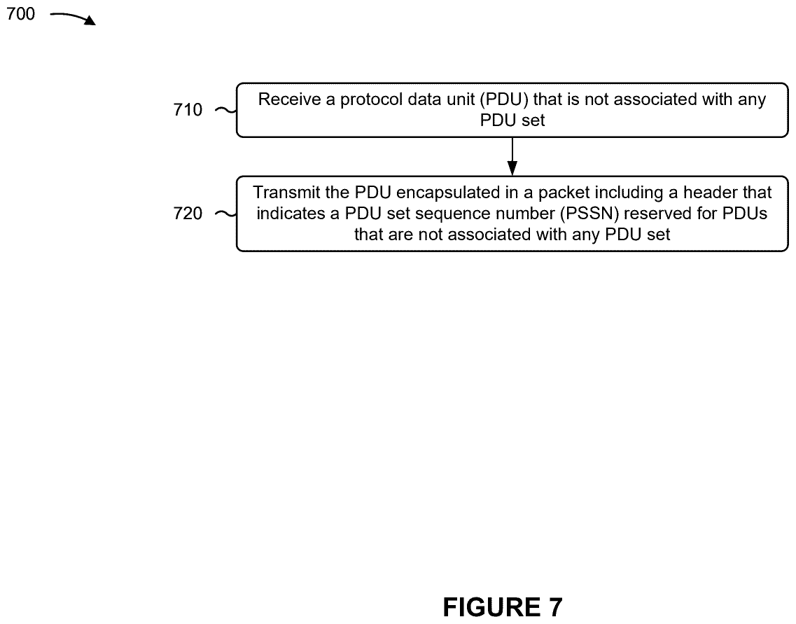

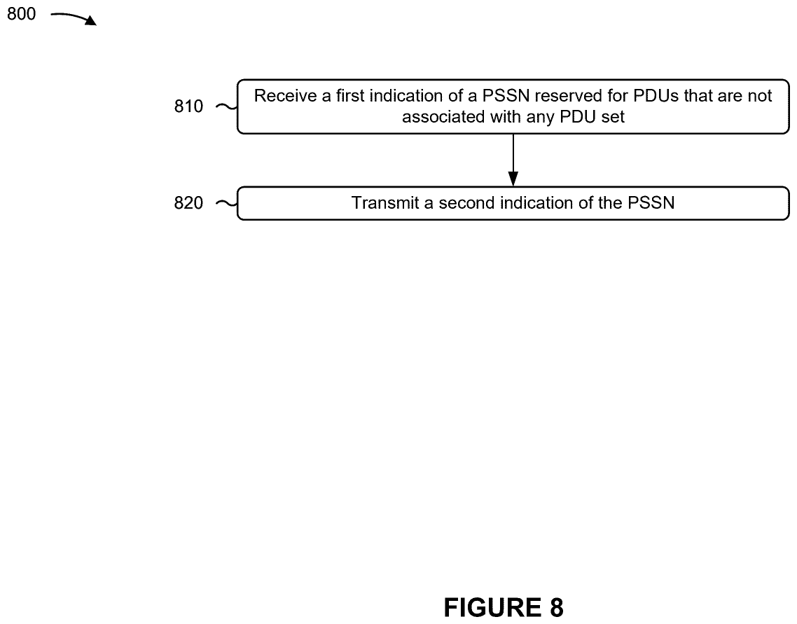

The network node 110, the processing system 145 of the network node 110, the UE 120, the processing system 140 of the UE 120, the CU 210, the DU 230, the RU 240, the UPF 125, the processing system 145 of the UPF 125, or any other component(s) of FIG. 1 and/or FIG. 2 may implement one or more techniques or perform one or more operations associated with reserved PSSNs, as described in more detail elsewhere herein. For example, the processing system 145 of the network node 110, the processing system 140 of the UE 120, the CU 210, the DU 230, the RU 240, the UPF 125, or the processing system 145 of the UPF 125, may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120, the memory of the network node 110, or memory of the UPF 125 may include a non-transitory computer-readable medium storing a set of instructions for wired and/or wireless communication. For example, the set of instructions, when executed by one or more processors (for example, of the processing system 145, the processing system 140, or the processing system 148) of the network node 110, the UE 120, the CU 210, the DU 230, the RU 240, or the UPF 125, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

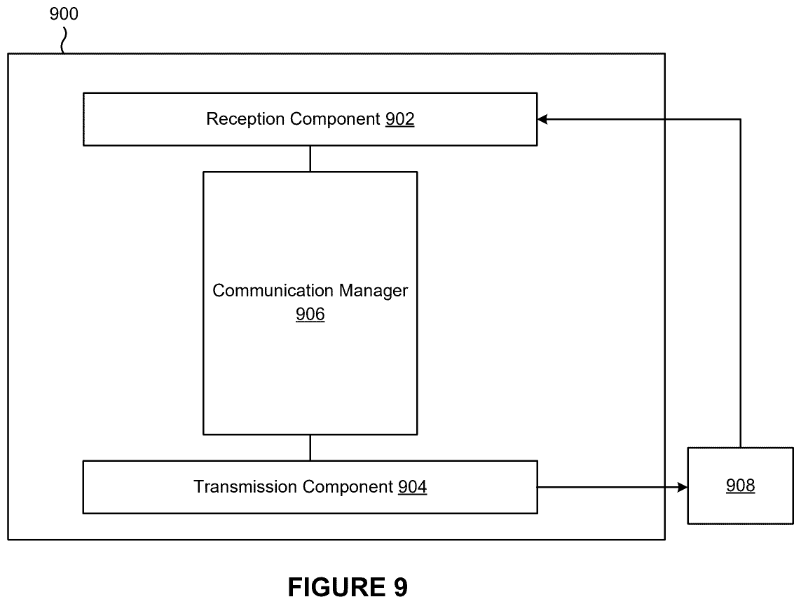

In some aspects, the network node 110 includes means for receiving a PDU that is not associated with any PDU set; and/or means for transmitting the PDU encapsulated in a packet including a header that indicates a PSSN reserved for PDUs that are not associated with any PDU set. In some aspects, the means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, the UPF 125 includes means for receiving a PDU that is not associated with any PDU set; and/or means for transmitting the PDU encapsulated in a packet including a header that indicates a PSSN reserved for PDUs that are not associated with any PDU set. In some aspects, the means for the UPF 125 to perform operations described herein may include, for example, one or more of communication manager 158, processing system 148, a reception component (for example, reception component 902 depicted and described in connection with FIG. 9), and/or a transmission component (for example, transmission component 904 depicted and described in connection with FIG. 9), among other examples.

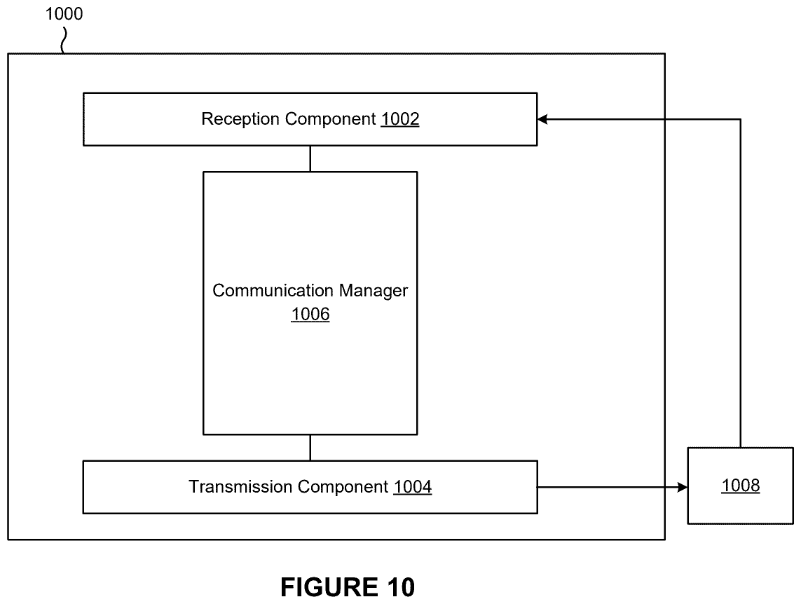

In some aspects, the UE 120 includes means for receiving a first indication of a PSSN reserved for PDUs that are not associated with any PDU set; and/or means for transmitting a second indication of the PSSN. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

FIG. 7 is a flowchart illustrating an example process 700 performed, for example, at a network entity or an apparatus of a network entity that supports reserved PSSNs in accordance with the present disclosure. Example process 700 is an example where the apparatus or the network entity (for example, the network node 110 or the UPF 125) performs operations associated with reserved PSSNs.

As shown in FIG. 7, in some aspects, process 700 may include receiving a PDU that is not associated with any PDU set (block 710). For example, the network entity (such as by using communication manager 906 or reception component 902, depicted in FIG. 9) may receive a PDU that is not associated with any PDU set, as described above.

As further shown in FIG. 7, in some aspects, process 700 may include transmitting the PDU encapsulated in a packet including a header that indicates a PSSN reserved for PDUs that are not associated with any PDU set (block 720). For example, the network entity (such as by using communication manager 906 or transmission component 904, depicted in FIG. 9) may transmit the PDU encapsulated in a packet including a header that indicates a PSSN reserved for PDUs that are not associated with any PDU set, as described above.

Process 700 may include additional aspects, such as any single aspect or any combination of aspects described below or in connection with one or more other processes described elsewhere herein.

In a first additional aspect, one or more values of a subset of a set of bits of the PSSN are reserved for the PDUs that are not associated with any PDU set.

In a second additional aspect, alone or in combination with the first aspect, the subset includes an MSB of the PSSN.

In a third additional aspect, alone or in combination with one or more of the first and second aspects, the subset includes an MSB of the PSSN and a second MSB of the PSSN.

In a fourth additional aspect, alone or in combination with one or more of the first through third aspects, one or more values of each bit of the PSSN are reserved for the PDUs that are not associated with any PDU set.

In a fifth additional aspect, alone or in combination with one or more of the first through fourth aspects, the PDU is a downlink PDU, and the network entity is a UPF.

In a sixth additional aspect, alone or in combination with one or more of the first through fifth aspects, the PDU is an uplink PDU, and the network entity is a network node.

In a seventh additional aspect, alone or in combination with one or more of the first through sixth aspects, the PDU is an IP packet, the packet is a GTP-U packet, and the header is a GTP-U header.

In an eighth additional aspect, alone or in combination with one or more of the first through seventh aspects, the PSSN is stored in a memory of the network entity.

In a ninth additional aspect, alone or in combination with one or more of the first through eighth aspects, process 700 includes receiving an indication of the PSSN.

In a tenth additional aspect, alone or in combination with one or more of the first through ninth aspects, the PDU is a downlink PDU, the network entity is a UPF, and receiving the indication of the PSSN includes receiving transport protocol assistance information that includes the indication of the PSSN.

In an eleventh additional aspect, alone or in combination with one or more of the first through tenth aspects, the PDU is an uplink PDU, the network entity is a network node, and receiving the indication of the PSSN includes receiving UE assistance information that includes the indication of the PSSN.

In a twelfth additional aspect, alone or in combination with one or more of the first through eleventh aspects, a value of the MSB is 1.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a UE or an apparatus of a UE that supports reserved PSSNs in accordance with the present disclosure. Example process 800 is an example where the apparatus or the UE (for example, UE 120) performs operations associated with reserved PSSNs.

As shown in FIG. 8, in some aspects, process 800 may include receiving a first indication of a PSSN reserved for PDUs that are not associated with any PDU set (block 810). For example, the UE (such as by using communication manager 150 or reception component 1002, depicted in FIG. 10) may receive a first indication of a PSSN reserved for PDUs that are not associated with any PDU set, as described above.

As further shown in FIG. 8, in some aspects, process 800 may include transmitting a second indication of the PSSN (block 820). For example, the UE (such as by using communication manager 150 or transmission component 1004, depicted in FIG. 10) may transmit a second indication of the PSSN, as described above.

Process 800 may include additional aspects, such as any single aspect or any combination of aspects described below or in connection with one or more other processes described elsewhere herein.

In a first additional aspect, receiving the first indication of the PSSN includes receiving a session setup message that includes the first indication of the PSSN.

In a second additional aspect, alone or in combination with the first aspect, transmitting the second indication of the PSSN includes transmitting UE assistance information that includes the second indication of the PSSN.

In a third additional aspect, alone or in combination with one or more of the first and second aspects, one or more values of a subset of a set of bits of the PSSN are reserved for the PDUs that are not associated with any PDU set.

In a fourth additional aspect, alone or in combination with one or more of the first through third aspects, the subset includes an MSB of the PSSN.

In a fifth additional aspect, alone or in combination with one or more of the first through fourth aspects, the subset includes an MSB of the PSSN and a second MSB of the PSSN.

In a sixth additional aspect, alone or in combination with one or more of the first through fifth aspects, one or more values of each bit of the PSSN are reserved for the PDUs that are not associated with any PDU set.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports reserved PSSNs in accordance with the present disclosure. The apparatus 900 may be a network entity, or a network entity may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145 or 148). In some aspects, the communication manager 906 is the communication manager 155 or the communication manager 158.

In some aspects, the apparatus 900 may be configured to and/or operable to perform one or more operations described herein in connection with FIGS. 5-6. Additionally or alternatively, the apparatus 900 may be configured to and/or operable to perform one or more processes described herein, such as process 700 of FIG. 7.

The reception component 902 may receive communications, such as reference signals, control information, and/or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the network entity described above in connection with FIG. 1, such as a radio, one or more RF chains, one or more transceivers, or one or more modems, each of which may in turn be coupled with one or more antennas of the network entity.

The transmission component 904 may transmit communications, such as reference signals, control information, and/or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the network entity described above in connection with FIG. 1, such as a radio, one or more RF chains, one or more transceivers, or one or more modems, each of which may in turn be coupled with one or more antennas of the network entity. In some aspects, the transmission component 904 may be co-located with the reception component 902.

The communication manager 906 may receive or may cause the reception component 902 to receive a PDU that is not associated with any PDU set. The communication manager 906 may transmit or may cause the transmission component 904 to transmit the PDU encapsulated in a packet including a header that indicates a PSSN reserved for PDUs that are not associated with any PDU set. In some aspects, the communication manager 906 may perform one or more operations described elsewhere herein as being performed by one or more components of the communication manager 906.

The reception component 902 may receive a PDU that is not associated with any PDU set. The transmission component 904 may transmit the PDU encapsulated in a packet including a header that indicates a PSSN reserved for PDUs that are not associated with any PDU set. In some aspects, the reception component 902 may receive an indication of the PSSN.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports reserved PSSNs in accordance with the present disclosure. The apparatus 1000 may be a UE, or a UE may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 140). In some aspects, the communication manager 1006 is the communication manager 150

In some aspects, the apparatus 1000 may be configured to and/or operable to perform one or more operations described herein in connection with FIGS. 5-6. Additionally or alternatively, the apparatus 1000 may be configured to and/or operable to perform one or more processes described herein, such as process 800 of FIG. 8.

The reception component 1002 may receive communications, such as reference signals, control information, and/or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, and/or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE. In some aspects, the transmission component 1004 may be co-located with the reception component 1002.

The communication manager 1006 may receive or may cause the reception component 1002 to receive a first indication of a PSSN reserved for PDUs that are not associated with any PDU set. The communication manager 1006 may transmit or may cause the transmission component 1004 to transmit a second indication of the PSSN. In some aspects, the communication manager 1006 may perform one or more operations described elsewhere herein as being performed by one or more components of the communication manager 1006.

The reception component 1002 may receive a first indication of a PSSN reserved for PDUs that are not associated with any PDU set. The transmission component 1004 may transmit a second indication of the PSSN.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method for wireless communication by a network entity, comprising: receiving a protocol data unit (PDU) that is not associated with any PDU set; and transmitting the PDU encapsulated in a packet including a header that indicates a PDU set sequence number (PSSN) reserved for PDUs that are not associated with any PDU set.

Aspect 2: The method of Aspect 1, wherein one or more values of a subset of a set of bits of the PSSN are reserved for the PDUs that are not associated with any PDU set.

Aspect 3: The method of Aspect 2, wherein the subset includes a most significant bit (MSB) of the PSSN.

Aspect 4: The method of Aspect 2, wherein the subset includes a most significant bit (MSB) of the PSSN and a second MSB of the PSSN.

Aspect 5: The method of any of Aspects 1-4, wherein one or more values of each bit of the PSSN are reserved for the PDUs that are not associated with any PDU set.

Aspect 6: The method of any of Aspects 1-5, wherein the PDU is a downlink PDU, and the network entity is a user plane function (UPF).

Aspect 7: The method of any of Aspects 1-6, wherein the PDU is an uplink PDU, and the network entity is a network node.

Aspect 8: The method of any of Aspects 1-7, wherein the PDU is an internet protocol (IP) packet, the packet is a general packet radio service tunneling protocol user plane (GTP-U) packet, and the header is a GTP-U header.

Aspect 9: The method of any of Aspects 1-8, wherein the PSSN is stored in a memory of the network entity.

Aspect 10: The method of any of Aspects 1-9, further comprising: receiving an indication of the PSSN.

Aspect 11: The method of Aspect 10, wherein the PDU is a downlink PDU, the network entity is a user plane function (UPF), and receiving the indication of the PSSN includes receiving transport protocol assistance information that includes the indication of the PSSN.

Aspect 12: The method of Aspect 10, wherein the PDU is an uplink PDU, the network entity is a network node, and receiving the indication of the PSSN includes receiving user equipment (UE) assistance information that includes the indication of the PSSN.

Aspect 13: A method for wireless communication by a user equipment (UE), comprising: receiving a first indication of a protocol data unit (PDU) set sequence number (PSSN) reserved for PDUs that are not associated with any PDU set; and transmitting a second indication of the PSSN.

Aspect 14: The method of Aspect 13, wherein receiving the first indication of the PSSN includes receiving a session setup message that includes the first indication of the PSSN.

Aspect 15: The method of any of Aspects 13-14, wherein transmitting the second indication of the PSSN includes transmitting UE assistance information that includes the second indication of the PSSN.

Aspect 16: The method of any of Aspects 13-15, wherein one or more values of a subset of a set of bits of the PSSN are reserved for the PDUs that are not associated with any PDU set.

Aspect 17: The method of Aspect 16, wherein the subset includes a most significant bit (MSB) of the PSSN.

Aspect 18: The method of Aspect 16, wherein the subset includes a most significant bit (MSB) of the PSSN and a second MSB of the PSSN.

Aspect 19: The method of any of Aspects 13-18, wherein one or more values of each bit of the PSSN are reserved for the PDUs that are not associated with any PDU set.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19 or 27.

Aspect 21: An apparatus for wireless communication at a device, the apparatus comprising one or more memories and one or more processors coupled to the one or more memories, the one or more processors configured to cause the device to perform the method of one or more of Aspects 1-19 or 27.

Aspect 22: An apparatus for wireless communication, the apparatus comprising at least one means for performing the method of one or more of Aspects 1-19 or 27.

Aspect 23: A non-transitory computer-readable medium storing code for wireless communication, the code comprising instructions executable by one or more processors to perform the method of one or more of Aspects 1-19 or 27.

Aspect 24: A non-transitory computer-readable medium storing a set of instructions for wireless communication, the set of instructions comprising one or more instructions that, when executed by one or more processors of a device, cause the device to perform the method of one or more of Aspects 1-19 or 27.

Aspect 25: A device for wireless communication, the device comprising a processing system that includes one or more processors and one or more memories coupled with the one or more processors, the processing system configured to cause the device to perform the method of one or more of Aspects 1-19 or 27.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19 or 27.

Aspect 27: The method of any of Aspects 1-12, wherein a value of the MSB is 1.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network entity for wireless communication, comprising:
a processing system that includes one or more processors and one or more memories coupled with the one or more processors, the processing system configured to cause the network entity to:
receive a protocol data unit (PDU) that is not associated with any PDU set; and
transmit the PDU encapsulated in a packet including a header that indicates a PDU set sequence number (PSSN) reserved for PDUs that are not associated with any PDU set, wherein one or more values of a subset of a set of bits of the PSSN are reserved for the PDUs that are not associated with any PDU set, and wherein the subset includes a most significant bit (MSB) of the PSSN.

2. The network entity of claim 1, wherein the PDU is a downlink PDU, and the network entity is a user plane function (UPF).

3. The network entity of claim 1, wherein the PDU is an uplink PDU, and the network entity is a network node.

4. The network entity of claim 1, wherein the PDU is an internet protocol (IP) packet, the packet is a general packet radio service tunneling protocol user plane (GTP-U) packet, and the header is a GTP-U header.

5. The network entity of claim 1, wherein the PSSN is stored in a memory of the network entity.

6. The network entity of claim 1, wherein the processing system is further configured to cause the network entity to:
receive an indication of the PSSN.

7. The network entity of claim 6, wherein the PDU is a downlink PDU, the network entity is a user plane function (UPF), and, to cause the network entity to receive the indication of the PSSN, the processing system is configured to cause the network entity to receive transport protocol assistance information that includes the indication of the PSSN.

8. The network entity of claim 6, wherein the PDU is an uplink PDU, the network entity is a network node, and, to cause the network entity to receive the indication of the PSSN, the processing system is configured to cause the network entity to receive user equipment (UE) assistance information that includes the indication of the PSSN.

9. The network entity of claim 1, wherein a value of the MSB is 1.

10. A network entity for wireless communication, comprising:
a processing system that includes one or more processors and one or more memories coupled with the one or more processors, the processing system configured to cause the network entity to:
receive a protocol data unit (PDU) that is not associated with any PDU set; and
transmit the PDU encapsulated in a packet including a header that indicates a PDU set sequence number (PSSN) reserved for PDUs that are not associated with any PDU set, wherein one or more values of each bit of the PSSN are reserved for the PDUs that are not associated with any PDU set.

11. The network entity of claim 10, wherein the PDU is a downlink PDU, and the network entity is a user plane function (UPF).

12. The network entity of claim 10, wherein the PDU is an uplink PDU, and the network entity is a network node.

13. The network entity of claim 10, wherein the PDU is an internet protocol (IP) packet, the packet is a general packet radio service tunneling protocol user plane (GTP-U) packet, and the header is a GTP-U header.

14. The network entity of claim 10, wherein the PSSN is stored in a memory of the network entity.

15. The network entity of claim 10, wherein the processing system is further configured to cause the network entity to:
receive an indication of the PSSN.

16. The network entity of claim 15, wherein the PDU is a downlink PDU, the network entity is a user plane function (UPF), and, to cause the network entity to receive the indication of the PSSN, the processing system is configured to cause the network entity to receive transport protocol assistance information that includes the indication of the PSSN.

17. The network entity of claim 15, wherein the PDU is an uplink PDU, the network entity is a network node, and, to cause the network entity to receive the indication of the PSSN, the processing system is configured to cause the network entity to receive user equipment (UE) assistance information that includes the indication of the PSSN.

18. A method for wireless communication by a network entity, comprising:
receiving a protocol data unit (PDU) that is not associated with any PDU set; and
transmitting the PDU encapsulated in a packet including a header that indicates a PDU set sequence number (PSSN) reserved for PDUs that are not associated with any PDU set, wherein one or more values of a subset of a set of bits of the PSSN are reserved for the PDUs that are not associated with any PDU set, and wherein the subset includes a most significant bit (MSB) of the PSSN.

19. The method of claim 18, wherein the PDU is a downlink PDU, and the network entity is a user plane function (UPF).

20. The method of claim 18, wherein a value of the MSB is 1.
